(19) United States
(12) Patent Application Publication
(10) Pub. No.: US 2005/0095008 A1
(43) Pub. Date: May 5, 2005

(54) Configurator tool for optical networking devices

(75) Inventors: Casimer M. DeCusatis, Poughkeepsie, NY (US); Robert C. Browning, Highland, NY (US); Richard D. Carroll, Poughkeepsie, NY (US); Frank S. Lasko JR., Poughkeepsie, NY (US)

Correspondence Address: Floyd A. Gonzalez;IBM Corporation, P386, 2455 South Road, Poughkeepsie, NY, 12601, US

(73) Assignee: International Business Machines Corporation, Armonk, NY (US)

(21) Appl. No.: 10/700,847

(22) Filed: Nov. 4, 2003

(51) Int. Cl. H04B 10/00

(52) U.S. Cl. 398/164

(57) ABSTRACT

A configurator tool, method, program product and service for configuring an optical network wherein an input device is used to input a proposed configuration of the optical network where the proposed configuration is different from the present configuration. A processor evaluates the proposed configuration of the optical network and determines needed components to complete the proposed configuration. An output device provides a listing of needed components determined by the processor. The output device may include automatically ordering the needed components from suppliers. In one embodiment, the processor may design several variations of the proposed configuration, and optimize the design.

### BACKGROUND OF THE INVENTION

The present invention is related to providing a configurator tool for optical networking devices and is more particularly related to configuration of Dense Wavelength Division Multiplexing (DWDM) equipment options for data communication and telecommunications.

Enterprise servers or mainframes typically offer many features, including different options for input/output channels, power cables, processor types, etc. which must be specified when planning or ordering a new system, and then communicated to the manufacturing line. Many telecom companies and Internet companies have built equipment at the customer's location, and charge a premium fee for setup and installation to the customer's specification. This setup takes much longer compared with shipping an integrated solution, and has lower reliability since workers must assemble the equipment in the field, and the customer's system is never tested as a unit prior to installation providing more opportunities for installation errors. Configurator tools have been used to allow customers and marketing representatives to plan the options on a computer order or upgrade, and then generate orders and pricing information as well as instructions for manufacturing, assembly, and functional test of the desired system configuration. These tools are typically software tools which are standardized across many product lines, and thus it is desirable to use them for new products such as optical networking equipment, specifically dense wavelength multiplexers such as the IBM 2029 Fiber Saver.

Many networking products offer a huge assortment of possible configuration options as compared with even a mainframe computer. Furthermore, these devices require instructions on where specific cards must be plugged to achieve the desired function, rather than simply using the first available card slot. Assignment of feature codes in this case becomes very complex, and if not done properly may require many thousands of codes and part numbers, making it impractical to simply extend the existing configuration tool to handle these situations. However, since optical networking equipment, particularly wavelength multiplexers, have become strategic elements of the enterprise server portfolio, a new way must be found to enable automatic configuration of these systems.

As an example, the IBM 2029 Fiber Saver configuration options consists of up to 8 equipment shelves which are daisy chained together to achieve larger channel counts. As shown in FIG. 1, each shelf 10 is divided into an East 11 and West 12 half for protection switching (high availability); cards 14 plugged on the east side use one pair of fibers (not shown), while cards 15 on the west side use a second pair of fibers (not shown). The OCI and OCLD cards (to be discussed later) in each half are controlled by management cards 16 and 17. The output of the OCLD cards are multiplexed by Optical Multiplex Cards (OMX) 18 and 19 to supply the output signals. The east and west fiber trunks can either carry independent channels of data (base or unprotected mode), or can be configured so that one channel is split between the east and west paths for redundancy in case of a fiber break or card failure in the system (protected or high availability (HA) mode). Individual channels may be configured as either protected or unprotected, and the two types may be mixed in a shelf. Each shelf supports up to 4 protected or 8 unprotected channels, or a mix of the two (3 protected/2 unprotected, etc.). Thus, customers need to specify where they will plug, say, an ESCON channel, depending on whether or not it is protected. Furthermore, each channel card on the 2029 can be configured in software to support up to 11 different protocols, with more options in the future (such protocols include ESCON, FICON, Fibre Channel, ISC 1/2, ISC 3, ETR, CLO, ATM 155, ATM 622, Fast Ethernet, Gigabit Ethernet). Since these protocols have different physical layers, a patch panel inside the 2029 must be configured with the proper connector type (ESCON duplex connector, SC Duplex duplex type subscriber connector, MT-RJ optical connector, LC optical connector) and the proper fiber type (singlemode (SM), multimode (MM) 50 micron, MM 62.5 micron, MM 50 micron with attenuation, MM 62.5 micron with attenuation, mode conditioner for 50 micron, mode conditioner for 62.5 micron). Not all options are allowed for all protocols (mode conditioners are only allowed for FICON, Fibre Channel, and Gigabit Ethernet long wavelength (LX); some protocols such as External Timing Reference Protocol (ETR) and Control Link Oscillator Protocol (CLO) may not be configured as protected, etc.) and some options are allowed for multiple protocols (ESCON may be SM or MM, and if MM may use ether the MT-RJ or legacy ESCON connector). The total number of possible combinations is well over several thousand on a new build machine, and when upgrades are included that can change one protocol to another, reconfigure protected and unprotected channels, etc. the total number of possible combinations becomes unmanageable without some form of planning and configuration software.

A configurator tool is known which was developed to address complex configuration problems such as the 2029 Fiber Saver. The tool is also applicable to other networking equipment and allows customized placement of cards within a shelf and components within an equipment rack, including specifications for protected/unprotected networks and different protocol combinations in hardware and software.

The configurator software provides both automatic and customized configuration placement options. The current ordering process is based on feature codes; these codes are also used by manufacturing to determine how to configure a product, especially in the case of dealing with an OEM contract manufacturing source. Therefore, it was necessary to translate all possible box configuration options into feature codes. The shortest possible feature code is desirable and should remain backward compatible with legacy systems. Therefore, 4 digit fixed length feature codes are used to provide for the representation of all possible configurations on the product. To accomplish this, the first 2 digits of the feature code are encoded to represent the protocol being used, and the last 2 digits are encoded with the plugging location (card slot position). In this way, a particular feature code defines which protocol is plugged into which location. The adapter cable and facia associated with a given protocol are automatically ordered when that protocol is selected and plugged into the proposed configuration; a different set of feature codes was used to denote options such as different optical interface types for the same protocol. In this way, it is possible to configure all the possible options on a system with significantly fewer feature codes than would be required using a brute force approach of offering a different code for each card, facia, and cable, then having to specify in a separate system the card plugging location. The configurator was then provided with a set of user selectable menu options designed to reduce the complexity of creating the final product configuration. For example, a screen prompts whether the desired configuration is point-to-point with 2 fibers (unprotected), 4 fibers (protected or unprotected) or ring; if ring is selected, the user inputs the total number of locations (up to 8 remotes and a hub). Subsequent screens then refer to the configuration at each site in turn, and check to insure there is always a 1 to 1 correspondence between channels at the hub and the corresponding remote sites. The configurator performs validation of the order entry (input configuration) in other ways as well, such as insuring that no cards are plugged in the west side of the box if a 2 fiber configuration has been selected, and insuring that the proper number of multiplexed cards is ordered depending on whether the configuration is protected or not.

The configurator tool can be used when planning a new installation or an upgrade to an existing installation; it provides a means of validating a proposed design, and what that design will cost. Alternatives with different costs may then be explored (for example, unprotected vs. protected channel types). It also minimizes cost by insuring that all shelves are full to their maximum capacity, and allows for the planning of excess capacity in the future.

U.S. Pat. No. 5,515,367 issued May 7, 1996 to Cox, Jr. et al. for METHOD AND SYSTEM FOR PLANNING AND INSTALLING COMMUNICATION NETWORKS discloses a method for use in cooperation with a computer having memory in a Synchronous Optical Network for generating an optimized transition plan for the placement of Self-Healing Rings and the routing of point-to-point demand in accordance with projected customer demand over a selected multi-period time interval.

U.S. Pat. No. 5,923,646 issued Jul. 13, 1999 to Mandhyan for METHOD FOR DESIGNING OR ROUTING A SELF-HEALING RING IN A COMMUNICATIONS NETWORK AND A SELF-HEALING RING ROUTED IN ACCORDANCE WITH THE METHOD discloses a method for finding or routing a ring containing predetermined ring offices of a communications network while minimizing cost of communications channels used to route the ring.

U.S. Pat. No. 5,959,986 issued Sep. 28, 1999 to Nelson et al. for LIGHTWAVE TRANSMISSION TELECOMMUNICATIONS SYSTEM EMPLOYING A STACKED MATRIX ARCHITECTURE discloses a lightwave telecommunications matrix configuration for use in a fiber-optic telecommunications network and includes interface circuits for interfacing with an external fiber-optic circuit.

U.S. Pat. No. 5,974,127 issued Oct. 26, 1999 to Werni et al. for METHOD AND SYSTEM FOR PLANNING A TELECOMMUNICATIONS NETWORK discloses a method and system for planning a future telecommunications network from an existing telecommunications network interconnecting a plurality of users and utilizes an input device for determining future demands for the future telecommunications network.

U.S. Pat. No. 6,061,335 issued May 9, 2000 to De Vito et al. for METHOD FOR DESIGNING SONET RING NETWORKS SUITABLE FOR LOCAL ACCESS discloses a method for designing a hierarchical architecture for a synchronous optical network given a plurality of demand nodes at which communications traffic originates and at last one destination node at which the communications traffic is collected for transmission to a switch.

U.S. Pat. No. 6,094,417 issued Jul. 25, 2000 to Hansen et al. for METHOD AND SYSTEM FOR DETERMINING OPTIMIZED SONET RINGS discloses a SONET planning tool for generating optimized SONET rings bases on an existing SONET system capacity and anticipated system demand at minimal cost.

U.S. Pat. No. 6,185,193 B1 issued Feb. 6, 2001 to Kawakami et al. for DESIGNING SYSTEM AND METHOD FOR COMPUTER-AIDED ACCESS COMMUNICATION NETWORKS discloses an access communication network to make possible automatic designing a lower cost access communication network under various constraints by using existing equipment of the basis of demand information.

U.S. Pat. No. 6,229,540 B1 issued May 8, 2001 to Tonelli et al. for AUDITING NETWORKS discloses a method for designing networks including auditing a network to discover a present network configuration, creating a network design sheet form the discovered network configuration, placing device icons representing intelligent device objects on the network design sheet, selecting a media type representing an intelligent media object, and connecting the media type to a first one of the device icons. The method further including validating the connection to the first one of the device icons.

Lucent Technologies provides FiberGrafix Network Design Software for Windows which is a software tool that is used for designing both fiber optic enterprise and service provider networks. A drawing pad graphically constructs a fiber optic network and develops a corresponding list of the require Lucent Technologies' fiber optic cable and apparatus products.

### SUMMARY OF THE INVENTION

It is an object of the present invention to provide a configurator to optimize the Dense Wavelength Division Multiplexing (DWDM) card placement when using a (to be explained) transponder. As shown in FIGS. 2-4, the previous DWDM product required two separate cards for each channel (a client side or OCI card 20, and a network side or OCLD card 21). These two functions have been combined into a single card, called a transponder. The transponders are used to provide new features for the product, such as new protocol support. This also doubles the number of channels which can be accommodated per shelf since they plug into the same slots used by the Optical Channel Interface/Optical Channel Laser/Detecter (OCI/OCLD) cards. Thus, when an older channel is being upgraded or repaired, and two of the older cards can be replaced by one transponder card, it is necessary for the configurator to order a transponder card and a blank card (the blanks are required as placeholders in the DWDM shelf to maintain uniform airflow and protect against dust contamination) instead of the previous pair of OCI/OCLD cards. When a shelf is upgraded in this way, the configurator must also re-compute the total available network capacity for future upgrades. Another embodiment is a one slot transponder added to the shelf, for example, rather than requiring installation of a new shelf with two open slots for the two card solution. However, it is possible that a two card solution would be required anyway (not all protocols are supported on transponders). The present invention can automatically identify these cases from customer input. The ability to automatically search for a transponder card option when a configuration is requested, and modify the card placement accordingly, represents new functionality in the configurator which was previously not available.

It is another object of the present invention to provide for the fact that some cards now support more than one port, and different protocols can be mixed and matched on different ports. For example, previously each OCI/OCLD pair supported only one protocol. A new sub-rate mux (SRM) card has four ports, and supports a mix of four different protocols. The configurator recognizes and tracks this condition, so that the proper number of cards are ordered. These conditions have been addressed by assigning special characters to the four digit feature codes described earlier. For example, previously the feature code used two digits to determine the card protocol and two to determine shelf location. The last two digits are modified to special characters, for example 99, which are interpreted as transponder cards (able to plug in a single slot, any shelf location), or 88, which is interpreted as an SRM card (able to plug into available OCI card slots, but counts for up to four ports of supported protocols when calculating shelf capacity). Mapping the special card functions into a two digit code preserves the legacy configurator structure and enables automatic configuration and placement not previously possible. A four digit feature code offers advantages over longer or more redundant mapping alternative embodiments.

Another object of the present invention is to provide for support of new protocols, specifically 10 Gigabit Ethernet, Intersystem Channel Protocol 3 (ISC-3), also known as Hyperlinks, and InfiniBand support. In particular, ISC-3 is part of the Parallel Sysplex architecture and has unique requirements (it must not be protected, and all ISC-3 links must be split across east and west paths for continuous availability).

Another object of the present invention is to validate the topology on optically amplified networks. There are three ways to increase the supported distance on a DWDM link; (1) use adapter cards with longer reach optics (2) install optical amplifiers along the link path, (3) combine the previous two and use amplifiers together with enhanced reach adapters. These options all have different hardware configuration requirements; for example, option 1 requires an enhanced adapter card at both endpoints of the link, plugged into the same slot positions, while option 2 requires allowing for open slots in a shelf's east or west side. The configurator allows the user to specify only the distance between sites; the software then computes whether or not extended distance features are required, and if so it computes the relative cost of each of the three options shown above and recommends the lowest cost solution.

It is another object of the present invention to provide for vertical integration of this tool with the software for planning, ordering, manufacturing, and installing the network. This is a powerful feature which allows significant cost savings in the manufacturing and service/installation process.

It is another object of the present invention to provide for wavelength reuse and sub-wavelength reuse. The configurator plans for networks to re-use wavelengths in a meshed ring environment rather than incur the cost of installing new wavelengths that may not be necessary.

It is another object of the present invention to use the 4 digit feature codes as the basis for generating a metric to determine whether the Wavelength Division Multiplexing (WDM} network was optimized or not. As a simple example, all the feature codes are added for a given WDM system, the result is divided by a predetermined value, and a performance metric is generated. The configurator is then run many times and a Monte Carlo simulation is performed of the performance metrics for various cases to optimize the network configuration.

### BRIEF DESCRIPTION OF THE DRAWINGS

These and other objects will be apparent to one skilled in the art from the following detailed description of the invention taken in conjunction with the accompanying drawings in which:

FIG. 1 is a schematic diagram of a shelf of a prior art IBM 2029 configurator;

FIG. 2 is a diagram showing the symbols used herein to represent an optical signal and an electrical signal;

FIG. 3 is a schematic diagram of a prior art configurator showing the configuration for base (unprotected) channels for the configurator of FIG. 1;

FIG. 4 is a schematic diagram of a prior art configurator showing the configuration for HA (protected) channels for the configurator of FIG. 1;

FIG. 5 is a schematic diagram showing a transponder usable with the present invention;

FIG. 6 is a schematic diagram showing multi-port OCL cards;

FIG. 7 is a schematic diagram of a configurator tool of the present invention;

FIG. 8 is another embodiment of the present invention showing the use of amplifiers with the OCI and OCLD cards;

FIG. 9 is a representation of the 4 digit feature codes of the present invention;

FIG. 10 is a diagram showing the configurator tool of the present invention;

FIG. 11 is a flowchart of the program for one embodiment of the present invention; and

FIG. 12 is a diagram illustrating the wavelength reuse feature of the present invention.

### DESCRIPTION OF THE PREFERRED EMBODIMENT

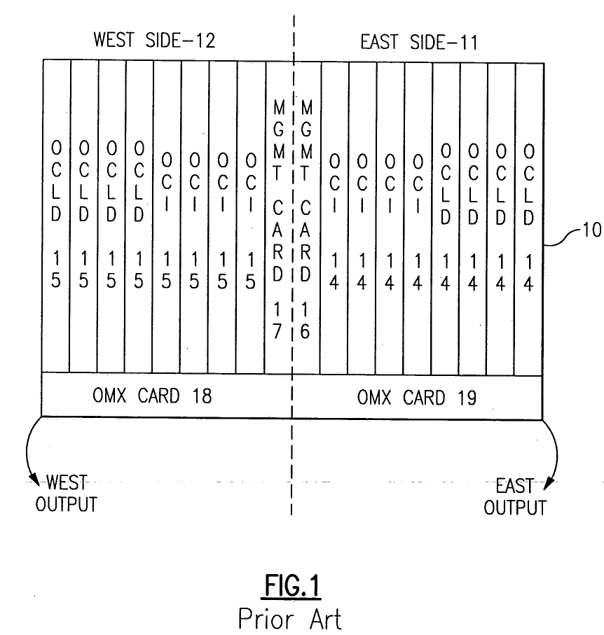

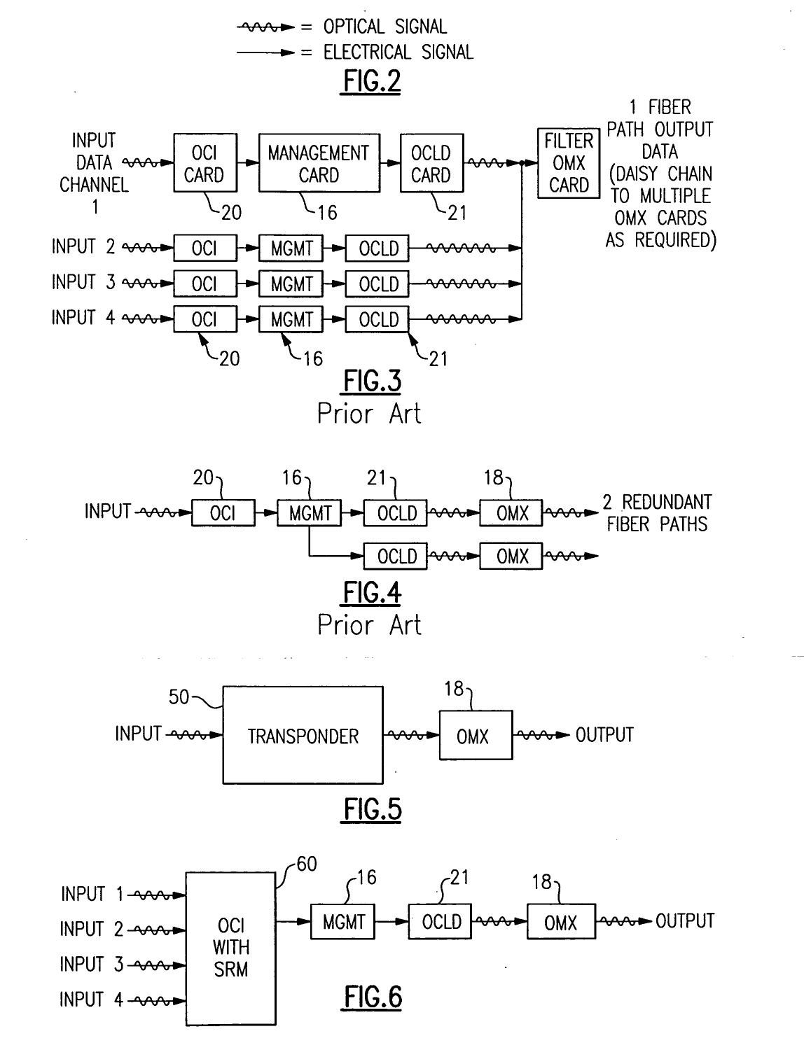

FIGS. 1-4 show the prior art configurator. As explained, the previous DWDM product required 2 separate cards for each channel (a client side or OCI card 20, and a network side or OCLD card 21). FIG. 5 shows the present transponder 50 which combines these 2 functions into a single card. The transponders 50 are used to provide new features for the product, such as new protocol support, which doubles the number of channels which can be accommodated per shelf since they plug into the same slots used by the Optical Channel Interface/Optical Channel Laser/Detecter (OCI/OCLD) cards. Thus, when an older channel is being upgraded or repaired, and two of the older cards 20 and 21 can be replaced by one transponder card 50, it is necessary for the configurator tool to order a transponder card 50 and a blank card (not shown) (the blanks are required as placeholders in the DWDM shelf 10 to maintain uniform airflow and protect against dust contamination) instead of the previous pair of OCI/OCLD cards 20 and 21. When a shelf 10 is upgraded in this way, the configurator tool must also re-compute the total available network capacity for future upgrades. Another embodiment of the invention is a one slot transponder added to the shelf 10, for example, rather than requiring installation of a new shelf with two open slots for the two card solution. However, it is possible that a two card solution would be required anyway (thus, not all protocols need to be supported on transponders 50). The present invention can automatically identify these cases from customer input. The ability to automatically search for a transponder card option when a configuration is requested, and modify the card placement accordingly, represents new functionality in the configurator which was previously not available.

As mentioned, the sub-rate mux (SRM) card 60 of FIG. 6 has four ports as shown, and supports a mix of four different protocols. The configurator recognizes and tracks this condition, so that the proper number of cards are ordered. These conditions have been addressed by assigning special characters to the four digit feature codes described earlier and shown in FIG. 9. As explained, the feature code 90 is a four digit code. For example, two digits 91 of the feature code determine the card protocol and two digits 92 determine shelf location. In the present invention, the last two digits 92 are modified to special characters, for example 99, which are interpreted as transponder cards 50 (able to plug in a single slot, any shelf location), or 88, which is interpreted as an SRM card 60 (able to plug into available OCI card slots, but counts for up to four ports of supported protocols when calculating shelf capacity). Mapping the special card functions into a two digit code preserves the legacy configurator structure and enables automatic configuration and placement not previously possible. A four digit feature code offers advantages over longer or more redundant mapping alternative embodiments. It will be understood that a particular feature code defines which protocol is plugged in which location. The adapter cable and facia associated with a given protocol are automatically ordered by the tool when that protocol is selected and plugged into the proposed configuration. A different set of feature codes is used to denote options such as different optical interface types for the same protocol. In this way, it is possible to configure all the possible options on a system with significantly fewer feature codes than would be required using a brute force approach of offering a different code for each card, facia, and cable, then having to specify in a separate system, the card plugging location.

The configurator tool is provided with a set of user selectable menu options designed to reduce the complexity of creating the final product configuration. For example, a screen prompts whether the desired configuration is point-to-point with two fibers (unprotected), 4 fibers (protected or unprotected) or ring If ring is selected, the user inputs the total number of locations (up to 8 remotes and a hub). Subsequent screens then refer to the configuration at each site in turn, and check to insure there is always a 1-to-1 correspondence between channels at the hub and the corresponding remote sites.

The configuration performs validation of the order entry (input configuration) in other ways as well, such as insuring that no cards are plugged into the west side of the box if a 2 fiber configuration has been selected, and insuring that the proper number of multiplexed cards is ordered depending on whether the configuration is protected or not.

In the present invention, an enhanced OLCD card is used in place of the previous OLCD card 21 of, for instance FIGS. 3 and 4, to provide for support of new protocols, specifically 10 Gigabit Ethernet, Intersystem Channel Protocol 3 (ISC-3), also known as Hyperlinks, and InfiniBand support. In particular, ISC-3 is part of the Parallel Sysplex architecture and has unique requirements (it must not be protected and is therefor used in the configuration shown in FIG. 3, and all ISC-3 links must be split across east and west paths for continuous availability).

The present invention validates the topology on optically amplified networks. There are three ways to increase the supported distance on a DWDM link; (1) use adapter cards with longer reach optics (2) install optical amplifiers along the link path, (3) combine the previous two and use amplifiers 80 of FIG. 8 together with enhanced reach adapters. These options all have different hardware configuration requirements; for example, option 1 requires an enhanced adapter card at both endpoints of the link, plugged into the same slot positions, while option 2 requires allowing for open slots in a shelf's east or west side. The configurator allows the user to specify only the distance between sites; the software then computes whether or not extended distance features are required, and if so it computes the relative cost of each of the three options shown above and recommends the lowest cost solution.

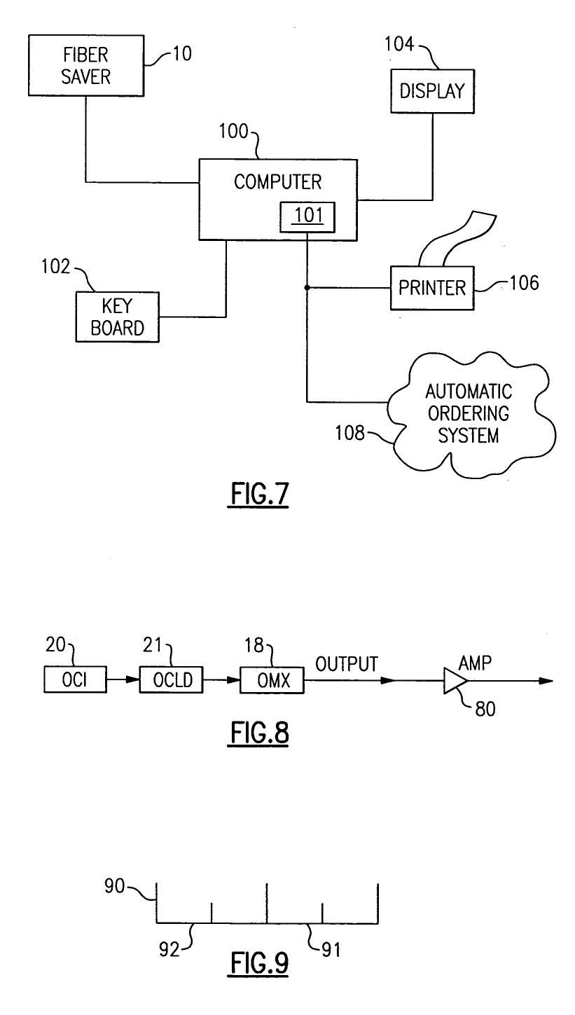

FIG. 7 is a diagram of the configurator of the present invention having a digital computer 100 with the configurator tool 101 installed thereon. The computer 100 may be connected to a configurator shelf 10 of, for instance, an IBM Fiber Saver as shown in FIG. 1 for receiving configuration data directly from the shelf 10, or may be connected to an input device such as a keyboard 102, for a user to input the configuration data. Such data may include the discussed feature codes for each slot of the shelf which indicates the protocols of the cards in the slots, the type of cards in the slots, and the identity of the slots, as has been discussed. A display device 104 may also be included to provide for interactive entry of the data, and to display the results of the configurator tool 101. Finally, an output device, such as a printer 106 is provided to print the output of the configurator tool, which is used to order the cards, connectors, cable, amplifiers, etc. which are necessary to provide the configuration determined by the configuration tool software 101.

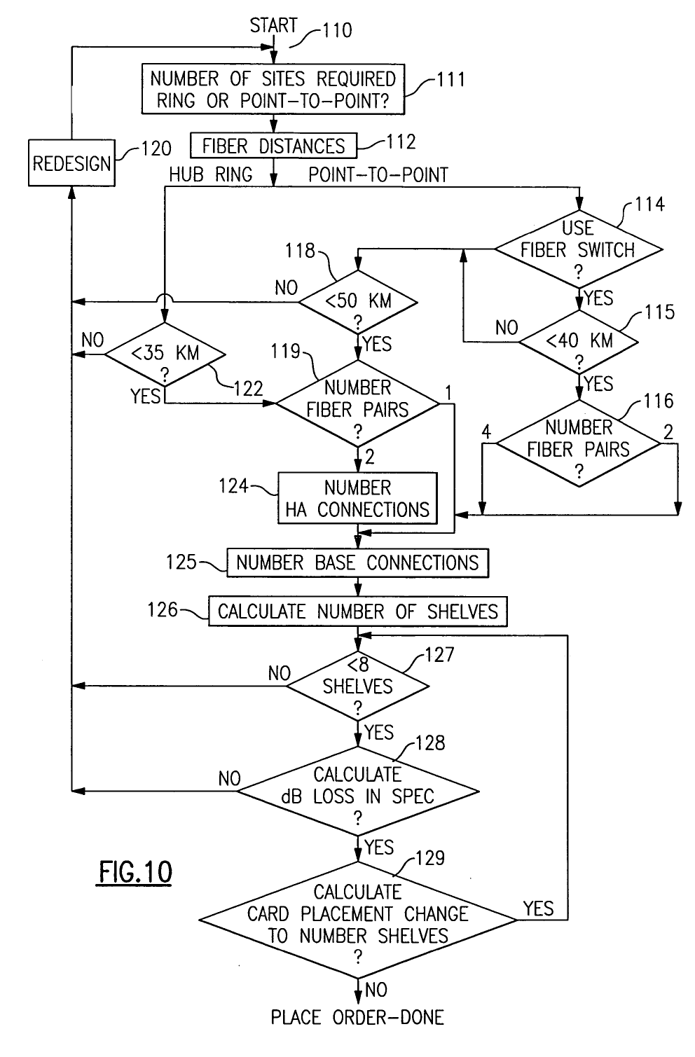

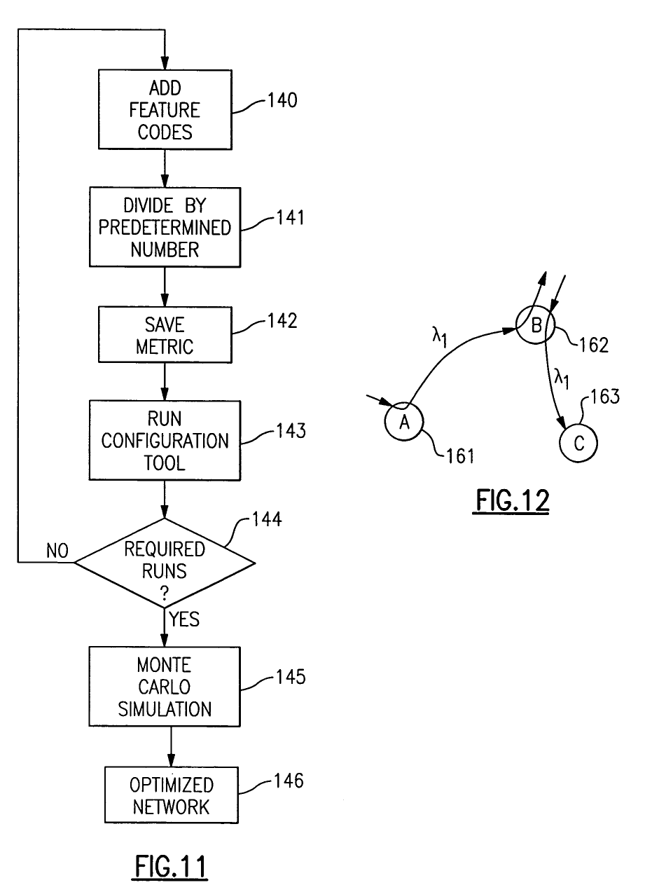

FIG. 10 is a flowchart of the software 101 of the configurator tool of FIG. 7. The program starts at 110. At 111, the user inputs in number of sites required by this configuration, and whether the configuration is a ring or point-to-point configuration. At 112, the fiber distances are inputted. If the configuration is point-to-point, as determined at 111, the program goes to 114 where the use of a fiber switch is determined. If a fiber switch is used, the program goes to 115. If the fiber distance is less than 40 Km, the number of fiber pairs (either 2 or 4) is determined at 116.

If it is determined at 114 that no fiber switch is used, or if the fiber distance is over 40 Km as determined at 115, the program goes to 118 to check if the fiber distance is less than 50 Km. If the fiber distance is less than 50 Km, the program goes to 119 where the number of fiber pairs (either 1 or 2) is determined.

If the fiber distance is over 50 Km, the program goes to 120 where the configuration is redesigned. This redesign includes the 3 options mentioned earlier wherein adapter cards with longer reach optics are included, optical amplifiers are installed along the link path, or a combination of both. After the redesign, the program returns to 111 and continues.

If the configuration is a hub ring, a check is made at 122 to determine if the fiber distance is less than 35 Km. If not, the program goes to redesign 120, as previously discussed.

If the check at 122 is yes, or the check at 119 is 2 fiber pairs, the program goes to 124 to determine the number of High Availability (HA) or protected connections that are present. The program then goes to 126. Also, if the number of fiber pairs at 119 is 1, or after the number of fiber pairs is determined at 116, the program goes to 125 where the number of base connections is determined. At 126, the program calculates the number of shelves needed for this configuration.

A check is made at 127 to determine the number of shelves that are needed for this configuration. If the number of shelves is over 8, the program goes to redesign to redesign a better configuration. If the number of shelves at 127 is less that 8, the program goes to 128 where the dB loss is calculated to determine if the loss is within predetermined specifications. If the loss is too great, the program goes back to redesign 120.

If the dB loss is within specification at 128, the program goes to 129 to calculate the card placement of this configuration and to determine if the number of shelves required has changed. If yes, the program returns to 127 to check of the number of shelves is less than 8. If the number of shelves has not changed at 129, the program outputs the order on, for instance, the printer 106. Another embodiment of the invention is to have the order placed into an automatic ordering system 108.

FIG. 11 is a flowchart of a program to optimize the network configuration. At 140, all of the feature codes for the configuration are added. The sum is then divided at 141 by a predetermined number to give a performance metric. This metric is then saved at 142, and the configurator tool is then run at 143 many times for different configurations. When the required runs have been made as determined at 144, a Monte Carlo simulation is performed at 145 for the various cases, and an optimized network configuration is determined at 146.

FIG. 12 is a diagram illustrating the reuse of wavelength λ1, for example in a meshed ring environment having node A, 161, node B, 162 and node C, 163. Optical wavelengths may be added or dropped at various nodes, and then reused to carry new traffic between a different pair of nodes. For example, in a three node network as shown in FIG. 12, a particular wavelength λ1 may be used to carry ESCON traffic between nodes 161 and 162, and the same wavelength λ1 may carry Ethernet traffic between nodes 162 and 163, thus eliminating the need for additional wavelengths in the network. The present invention keeps track of the wavelengths used between the nodes, the reusability of the wavelengths between the nodes of the network, and the hardware needed to support the wavelengths used.

The configurator tool 101 can be used when planning a new installation or an upgrade to an existing installation. It provides a means of validating a proposed design, and what that design will cost. Alternatives with different costs may then be explored (for example, unprotected vs. protected channel types). It also minimizes cost by insuring that all shelves are full to their maximum capacity, and allows for the planning of excess capacity in the future.

While the preferred embodiment of the invention has been illustrated and described herein, it is to be understood that the invention is not limited to the precise construction herein disclosed, and the right is reserved to all changes and modifications coming within the scope of the invention as defined in the appended claims.

1. A configurator tool for configuring an optical network, said configurator tool comprising:
an input device inputting a proposed configuration of the optical network, said proposed configuration being different than the present configuration;
a processor evaluating the proposed configuration of the optical network and determining needed components to complete the proposed configuration; and
an output device providing a listing of needed components determined by said processor.

2. The configurator tool of claim 1 wherein said components include transponder cards.

3. The configuration tool of claim 1 wherein said present configuration includes cards and said needed components include blank cards when cards of the proposed configuration determined by said processor are less than the present configuration requires.

4. The configuration tool of claim 1 wherein said output device includes an automatic ordering system which orders from suppliers said needed components.

5. The configuration tool of claim 1 wherein said input device includes inputting the length of links in said proposed configuration, and said processor determines needed components of said links based upon the length of the links.

6. The configuration tool of claim 5 wherein said needed components include:
adapter cards having longer reach optics, or
optical amplifiers to be installed along the link, or
a combination of cards having longer reach optics and optical amplifiers to be installed along the link.

7. The configuration tool of claim 1 wherein the configuration inputted by said input device include identifying cards in said configuration with a four digit feature code wherein two of said digits identify the card protocol and two of the digits identify the shelf location of the card in said configuration.

8. The configuration tool of claim 1 wherein the configuration inputted by said input device include identifying when a wavelength is reused between nodes of the configuration, and said processor determines said needed components supporting said reusing of said wavelength.

9. The configuration tool of claim 1 wherein said processor designs several variations of the needed components for said proposed configuration and further optimizes the design.

10. A method of configuring an optical network comprising:
inputting into a processor, a proposed configuration of the optical network, said proposed configuration being different than the present configuration;
evaluating with said processor, the proposed configuration of the optical network and determining needed components to complete the proposed configuration; and
Providing on an output device, a listing of needed components determined by said processor.

11. The method of claim 10 wherein said components include transponder cards.

12. The method of claim 10 wherein said present configuration includes cards and said needed components include blank cards when cards of the proposed configuration determined by said processor are less than the present configuration requires.

13. The method of claim 10 further comprising automatically ordering from suppliers, said needed components.

14. The method of claim 10 further comprising inputting the length of links in said proposed configuration, and determining needed components of said links based upon the length of the links.

15. The method of claim 14 wherein said needed components include:
adapter cards having longer reach optics, or
optical amplifiers to be installed along the link, or
a combination of cards having longer reach optics and optical amplifiers to be installed along the link.

16. The method of claim 10 wherein the configuration inputting includes identifying cards in said configuration with a four digit feature code wherein two of said digits identify the card protocol and two of the digits identify the location of the card in said configuration.

17. The method of claim 10 wherein said inputting by said input device includes identifying when a wavelength is reused between nodes of the configuration, and determining by said processor said needed components supporting said reusing of said wavelength.

18. The method of claim 10 further comprising designing several variations of the needed components for said proposed configuration and optimizing the design.

19. A program product of for configuring an optical network comprising:
A computer media having recorded thereon computer readable programmable program code for configuring an optical network, said computer readable programmable program code for implementing a method comprising:
inputting into a processor, a proposed configuration of the optical network, said proposed configuration being different than the present configuration;
evaluating with said processor, the proposed configuration of the optical network and determining needed components to complete the proposed configuration; and
providing on an output device, a listing of needed components determined by said processor.

20. The program product of claim 19 wherein said components include transponder cards.

21. The program product of claim 19 wherein said present configuration includes cards and said needed components include blank cards when cards of the proposed configuration determined by said processor are less than the present configuration requires.

22. The program product of claim 20 wherein said method further comprises automatically ordering from suppliers, said needed components.

23. The program product of claim 20 wherein said method further comprises inputting the length of links in said proposed configuration, and determining needed components of said links based upon the length of the links.

24. The program product of claim 23 wherein said needed components include:
adapter cards having longer reach optics, or
optical amplifiers to be installed along the link, or
a combination of cards having longer reach optics and optical amplifiers to be installed along the link.

25. The program product of claim 19 wherein the configuration inputting includes identifying cards in said configuration with a four digit feature code wherein two of said digits identify the card protocol and two of the digits identify the location of the card in said configuration.

26. The program product of claim 19 wherein said inputting by said input device includes identifying when a wavelength is reused between nodes of the configuration, and determining by said processor said needed components supporting said reusing of said wavelength.

27. The program product of claim 19 said method further comprises designing several variations of the needed components for said proposed configuration and optimizing the design.

28. Providing a service of configuring an optical network comprising:
inputting into a processor, a proposed configuration of the optical network, said proposed configuration being different than the present configuration;
evaluating with said processor, the proposed configuration of the optical network and determining needed components to complete the proposed configuration; and
providing on an output device, a listing of needed components determined by said processor.

29. The service of claim 28 wherein said components include transponder cards.

30. The service of claim 28 wherein said present configuration includes cards and said needed components include blank cards when cards of the proposed configuration determined by said processor are less than the present configuration requires.

31. The service of claim 28 further comprising automatically ordering from suppliers, said needed components.

32. The service of claim 28 further comprising inputting the length of links in said proposed configuration, and determining needed components of said links based upon the length of the links.

33. The service of claim 32 wherein said needed components include:
adapter cards having longer reach optics, or
optical amplifiers to be installed along the link, or
a combination of cards having longer reach optics and optical amplifiers to be installed along the link.

34. The service of claim 28 wherein the configuration inputting includes identifying cards in said configuration with a four digit feature code wherein two of said digits identify the card protocol and two of the digits identify the location of the card in said configuration.

35. The service of claim 28 wherein said inputting by said input device includes identifying when a wavelength is reused between nodes of the configuration, and determining by said processor said needed components supporting said reusing of said wavelength.

36. The service of claim 28 further comprising designing several variations of the needed components for said proposed configuration and optimizing the design.
